(19) United States
(12) Patent Application Publication
(10) Pub. No.: US 2024/0213723 A1
(43) Pub. Date: Jun. 27, 2024

(54) POWER ADAPTER WITH UNITED KINGDOM AND AUSTRALIA INTERCHANGEABLE BLADE WITH BUILT-IN FUSE IP-34 PROTECTION

(71) Applicants: Baxter International Inc., Deerfield, IL (US); Baxter Healthcare SA, Glattpark (Opfikon) (CH)

(72) Inventors: Sadhu Sharan Prasad, Chennai (IN); Vinayakrishnan Sankaran, Mysore (IN)

(21) Appl. No.: 18/545,915

(22) Filed: Dec. 19, 2023

(30) Foreign Application Priority Data
Dec. 27, 2022 (IN) 202241075891

(51) Int. Cl. H01R 13/692; H01R 13/213; H01R 13/22; H01R 13/62; H01R 13/625; H01R 13/629; H01R 13/635; H01R 31/06

(52) U.S. Cl. CPC H01R 13/692; H01R 13/213; H01R 13/22; H01R 13/6205; H01R 13/625; H01R 13/62911; H01R 13/635; H01R 31/06; H01R 2103/00

(57) ABSTRACT

Example systems, methods, and apparatus are disclosed herein for an interchangeable IPx4 UK blade with built-in fuse with a built-in fuse. The example systems, methods, and apparatus are configured to allow the user to replace used fuses from the interchangeable IPx4 UK blade with built-in fuse while providing water-sealing protection. Additionally, the example systems, methods, and apparatus are disclosed herein for an interchangeable IPx4 AU Blade. The disclosed systems, methods, and apparatus allow the user to use the interchangeable IPx4 AU Blade with all power adapters while providing water-sealing protection. Further, the disclosed systems, methods, and apparatus lower power adapter use cost by allowing the user to easily replace fuses without having to replace the entire power adapter. Finally, the disclosed systems, methods, and apparatus increase efficient power adapter use by orienting the power adapter such that electrical cords to not block unused power sockets.

### PRIORITY CLAIM AND CROSS-REFERENCE TO RELATED APPLICATIONS

The present application claims priority to Indian Patent Application No. 202241075891, filed on Dec. 27, 2022, and entitled POWER ADAPTER WITH UNITED KINGDOM AND AUSTRALIA INTERCHANGEABLE BLADE WITH BUILT-IN FUSE IP-34 PROTECTION, the contents of which are hereby incorporated by reference in their entirety.

### BACKGROUND

PCA pumps are commonly used for administering pain medication intravenously. Given that electric plug outlets vary throughout the world, the user must utilize power adapters with PCA pumps. Power adapters are available as interchangeable types with blades that can be swapped out. Power adapters from two particular regions of the world are of interest because of the issues they cause for the user: the United Kingdom (UK) and Australia (AU). Currently, UK power adapters only include fuses, for surge protection and IPx4 compliance, on their fixed side, and not the interchangeable blade. As such, when a fuse blows on a UK power adapter, the user must replace the entire power adapter, rather than the UK blade, which is costly. Additionally, in UK power adapters, when the blade couples onto the fixed side, the earth pin is oriented on the bottom of the power adapter, causing mounting issues and inconvenience.

In the case of the AU power adapter, the Live and Neutral pins are oriented in a swapped configuration, as compared to other regions of the world. In turn, the user cannot utilize the same power adapter, universally used elsewhere, if they are using it in Australia. Additionally, in AU power adapters, when the blade couples onto the fixed side, the blade is oriented on the power adapter in a configuration that causes mounting issues and inconvenience.

A need accordingly exists for a UK power adapter with an interchangeable blade with built-in Fuse and IPx4 protection and an assembled orientation such that the earth pin on the blade is located on the bottom of the power adapter. Relatedly, there is a need for an AU power adapter with a blade with a Live and Neutral pin configuration that universally matches the fixed power adapter Live and Neutral contacts.

### SUMMARY

Example systems, methods, and apparatus are disclosed herein for an interchangeable IPx4 UK blade with a built-in fuse. The example systems, methods, and apparatus are configured to allow the user to replace used fuses from the interchangeable IPx4 UK blade with built-in fuse while providing water-sealing protection. Additionally, the example systems, methods, and apparatus are disclosed herein for an interchangeable IPx4 AU Blade. The disclosed systems, methods, and apparatus allow the user to use the interchangeable IPx4 AU Blade with all power adapters while providing water-sealing protection. Further, the disclosed systems, methods, and apparatus lower power adapter use cost by allowing the user to easily replace fuses without having to replace the entire power adapter. Finally, the disclosed systems, methods, and apparatus increase efficient power adapter use by orienting the power adapter such that electrical cords to not block unused power sockets.

In light of the disclosure herein, and without limiting the scope of the invention in any way, in a first aspect of the present disclosure, which may be combined with any other aspect listed herein unless specified otherwise, an interchangeable IPx4 United Kingdom blade for a power adapter includes an a blade body that mates with a power adapter, a ground pin, a neutral pin, a live pin, an unlock button, a fuse holder, a fuse cover, and a fuse. The fuse sits inside the fuse holder and the fuse cover couples to the blade body with screws. Also, the blade body removably couples with a power adapter, Finally, the ground pin, neutral pin, and live pin are configured in a standard United Kingdom socket configuration.

In a second aspect of the present disclosure, which may be combined with any other aspect listed herein unless specified otherwise, the blade body includes engagement protrusions that mate with a power adapter.

In a third aspect of the present disclosure, which may be combined with any other aspect listed herein unless specified otherwise, the unlock button is mechanically connected to the engagement protrusions such that the user can engage the unlock button to selectively reconfigure the engagement protrusions.

In a fourth aspect of the present disclosure, which may be combined with any other aspect listed herein unless specified otherwise, the blade body mates with the power adapter and the engagement protrusions are oriented such that when the blade body mates with the power adapter, the power adapter points opposite the ground pin.

In a fifth aspect of the present disclosure, which may be combined with any other aspect listed herein unless specified otherwise, there is an IPx4 O-ring between the fuse holder and the fuse cover.

In a sixth aspect of the present disclosure, which may be combined with any other aspect listed herein unless specified otherwise, the unlock button is IPx4 sealed with the blade body.

In a seventh aspect of the present disclosure, which may be combined with any other aspect listed herein unless specified otherwise, when the blade body couples with the power adapter, the power adapter is oriented such that it points opposite the ground pin.

In an eight aspect of the present disclosure, which may be combined with any other aspect listed herein unless specified otherwise, the blade body includes an IPx4 gasket around the perimeter of the blade body area that mates with the power adapter.

In a ninth aspect of the present disclosure, which may be combined with any other aspect listed herein unless specified otherwise, the blade includes a blade magnet. The blade magnet is configured to selectively couple with a power adapter magnet on the power adapter.

In a tenth aspect of the present disclosure, which may be combined with any other aspect listed herein unless specified otherwise, the screws are M2.5 screws.

In an eleventh aspect of the present disclosure, which may be combined with any other aspect listed herein unless specified otherwise, the blade includes alignment guides configured to mate with corresponding alignment rails on the power adapter.

In a twelfth aspect of the present disclosure, which may be combined with any other aspect listed herein unless specified otherwise, an interchangeable IPx4 Australia blade for a power adapter includes a blade body that mates with a power adapter, a neutral pin, a live pin, and an unlock button. The blade body removably couples with a power adapter, and the neutral pin and live pin are configured in a standard Australia socket configuration. Finally, the neutral pin and live pin are configured inside the blade body such that they have a neutral area and alive area that mate with corresponding neutral contact and live contact points on the power adapter. Relatedly, the neutral pin and neutral area are configured diagonal to one another, and the live pin and live area are diagonal to one another.

In a thirteenth aspect of the present disclosure, which may be combined with any other aspect listed herein unless specified otherwise, the blade body mates with the power adapter, the blade body includes engagement protrusions that mate with a power adapter.

In a fourteenth aspect of the present disclosure, which may be combined with any other aspect listed herein unless specified otherwise, the unlock button is mechanically connected to the engagement protrusions such that the user can engage the unlock button to selectively reconfigure the engagement protrusions.

In a fifteenth aspect of the present disclosure, which may be combined with any other aspect listed herein unless specified otherwise, the blade body mates with the power adapter and the engagement protrusions are oriented such that when the blade body mates with the power adapter, the power adapter points opposite the neutral and live pin.

In a sixteenth aspect of the present disclosure, which may be combined with any other aspect listed herein unless specified otherwise, the unlock button is IPx4 sealed with the blade body.

In a seventeenth aspect of the present disclosure, which may be combined with any other aspect listed herein unless specified otherwise, the blade body includes an IPx4 gasket around the perimeter of the blade body area that mates with the power adapter.

In a eighteenth aspect of the present disclosure, which may be combined with any other aspect listed herein unless specified otherwise, the power adapter is oriented such that it points opposite the live and ground pins.

In a nineteenth aspect of the present disclosure, which may be combined with any other aspect listed herein unless specified otherwise, the blade includes a blade magnet. The blade magnet is configured to selectively couple with a power adapter magnet on the power adapter.

In a twentieth aspect of the present disclosure, which may be combined with any other aspect listed herein unless specified otherwise, the blade includes alignment guides configured to mate with corresponding alignment rails on the power adapter.

In a twenty-first aspect of the present disclosure, any of the structure, functionality, and alternatives disclosed in connection with any one or more of FIGS. 1 to 10 may be combined with any other structure, functionality, and alternatives disclosed in connection with any other one or more of FIGS. 1 to 10.

In light of the present disclosure and the above aspects, it is therefore an advantage of the present disclosure to decrease costs by allowing the user to replace the fuse in interchangeable UK blades rather than buying a completely new power adapter.

It is another advantage of the present disclosure to decrease costs by allowing the user to use the AU interchangeable blade with any power adapters because the AU interchangeable blade is configured to redirect the direction of the Live and Neutral pins, such that the blade is compatible with all power adapters.

It is yet another advantage of the present disclosure to provide UK and AU interchangeable blades that, when coupled with a power adapter, are oriented such that the electrical cords from the power adapter do not block any electrical sockets not in use.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a perspective view of a common fixed side power adapter, according to an example embodiment of the present disclosure.

FIG. 2 is a perspective view of a common fixed side power adapter head, according to an example embodiment of the present disclosure.

FIG. 3 is an assembly view of a common fixed side power adapter with an interchangeable IPx4 UK blade with built-in fuse, according to an example embodiment of the present disclosure.

FIGS. 4A-B are front and back view of an interchangeable IPx4 UK blade with built-in fuse, according to an example embodiment of the present disclosure.

FIG. 5 is an assembly view of an interchangeable IPx4 UK blade with built-in fuse, according to an example embodiment of the present disclosure.

FIG. 6 is an assembly view of a common fixed side power adapter with an interchangeable AU Blade, according to an example embodiment of the present disclosure.

FIG. 7A-B are front and back view of an interchangeable AU Blade, according to an example embodiment of the present disclosure.

FIG. 8 is an internal view of the interconnection between a common fixed side power adapter head and an interchangeable AU Blade, according to an example embodiment of the present disclosure.

FIG. 9 is a perspective view of a common fixed side power adapter with an interchangeable IPx4 UK blade with built-in fuse attached, according to an example embodiment of the present disclosure.

FIG. 10 is a perspective view of a common fixed side power adapter with an interchangeable AU Blade attached, according to an example embodiment of the present disclosure.

### DETAILED DESCRIPTION

Methods, systems, and apparatus are disclosed herein for an interchangeable IPx4 UK blade with built-in fuse and an interchangeable IPx4 UA blade. The example methods, systems, and apparatus are configured to allow users of an interchangeable UK blade to replace used fuses by selectively removing a fuse cover on the UK blade. Additionally, the example methods, systems, and apparatus are configured to provide IPx4 water-sealing protection for the electrical components in the UK blade. Finally, the example methods, systems, and apparatus are configured to orient the UK blade and power adapter such that any electrical cords from the power adapter do not block unused electrical sockets. As such, the user saves money easily replacing fuses on the UK blade, rather than buying a new power adapter. The user also has better ease of use because electrical cords do not block unused electrical sockets. Finally, the user can safely use the UK blade because it is IPx4 water-sealed

The example methods, systems, and apparatus are configured to allow users of an interchangeable AU blade to use the AU blade with any power adapters. In turn, the user does not have to purchase additional power adapters when using an AU blade. Additionally, the example methods, systems, and apparatus are configured to provide IPx4 water-sealing protection for the electrical components in the AU blade. Finally, the example methods, systems, and apparatus are configured to orient the AU blade and power adapter such that any electrical cords from the power adapter do not block unused electrical sockets. As such, the user also has better ease of use because electrical cords do not block unused electrical sockets. Finally, the user can safely use the AU blade because it is IPx4 water-sealed

While the example methods, apparatus, and systems are disclosed herein as interchangeable IPx4 United Kingdom and Australia blades, it should be appreciated that the methods, apparatus, and systems may be operable with interchangeable blades for other world regions. For example, the methods, apparatus, and systems may provide for interchangeable IPx4 blades for a different country like Mexico or Japan, and furthermore, depending on local regulations, may or may not include a built-in fuse.

### Common Fixed Side Power Adapter

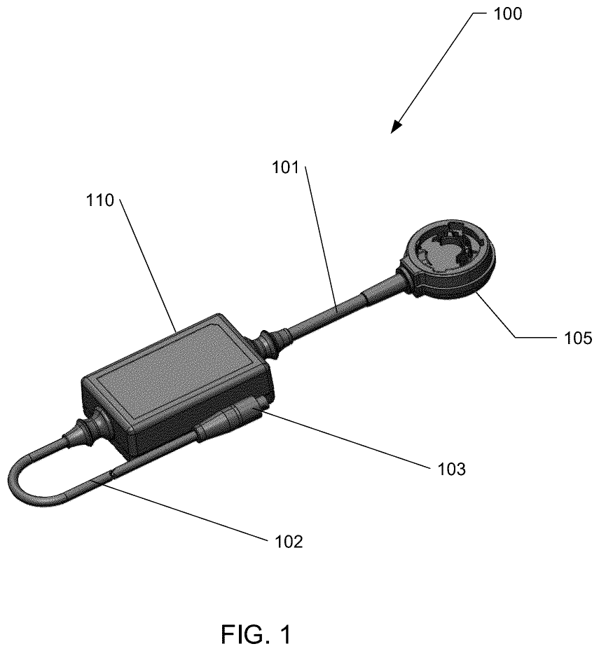

FIG. 1 is a perspective view of a common fixed side power adapter 100. The power adapter includes a main body 110 and a power adapter head 105. As seen in FIG. 1. The main body 110 couples to the head 105, with an electrical cord 101 connecting the main body 110 and the head 105 on one end and a second electrical cord 102 on the opposite end. It should be noted that the end of the second electrical cord 102 has a connection 103 that can couple to a device, such as a PCA pump, in order to power it. The connection 103 can couple to a device by mechanical means, such as a male-female connector relationship, or by a magnetic connection.

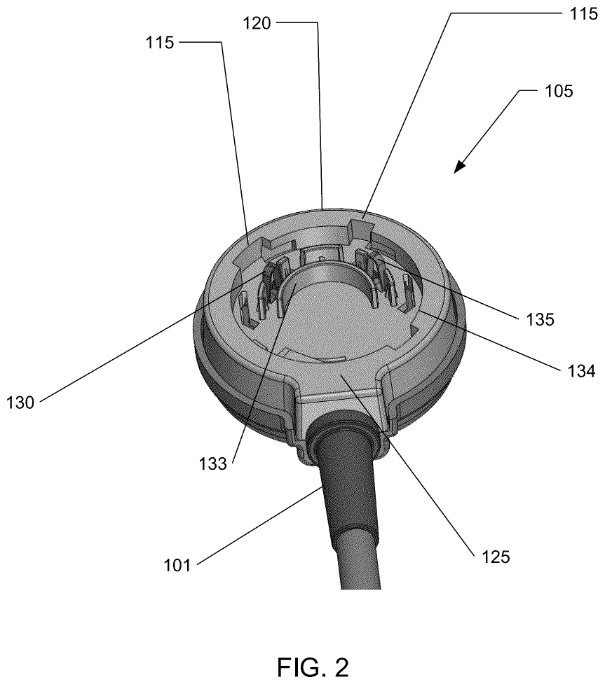

FIG. 2 is a perspective view of a common fixed side power adapter head 105. The head 105 has bottom side 125 where it couples to the electrical cord 101 from FIG. 1, and a top side 120 that is opposite the bottom side 125. The head 105 has an overall circular shape, with an internal circular indented portion 134. The perimeter of the internal circular indented portion 134 includes various engagement cavities 115 configured to interlock with engagement protrusions (not shown) on a removable blade (not shown). Additionally, the indented portion 134 includes a plurality of alignment guides 133 that protrude outwardly and engage with corresponding alignment rails (not shown) on the blade. Together, the engagement cavities 115 and alignment guides 133 from the adapter head 105 interact with the engagement protrusions on the removable blade to orient the removable blade correctly. The configuration, shape and size of the alignment guides 133 may vary in different embodiments. The indented portion also includes a Live contact 135 and a Neutral contact 130. The contacts 133, 135 are located opposite of one another and, in this embodiment, are flanked by the alignment guides 133 in a semi-circular fashion. In the inside of the adapter head 105, the Live contact 135 is electrically-coupled to a Live wire 340 and the Neutral contact 133 is electronically-coupled to a Neutral wire 335. The Live wire and Neutral wire exit the adapter head 105 an electrical cord 101 on the bottom side 125. In some embodiments, the adapter head 105 and removable blade further include magnetic components configured to couple the adapter head 105 and removable blade.

### Interchangeable IPx4 United Kingdom Blade

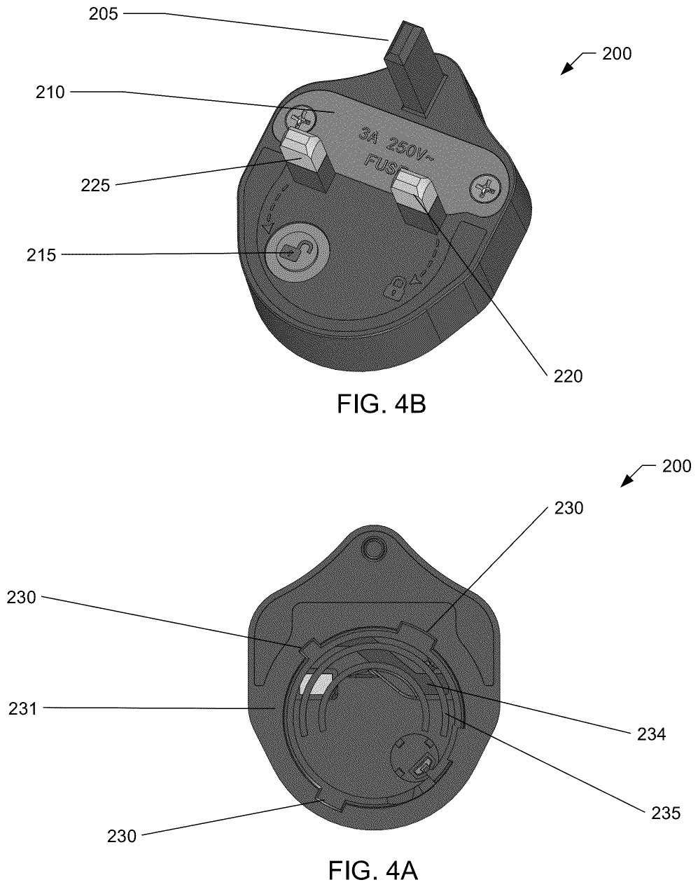

The FIGS. 4A-B are front and back view of an interchangeable IPx4 UK blade with built-in fuse 200. As seen in FIG. 4B, the front of the interchangeable IPx4 UK blade with built-in fuse (UK blade) 200 has a standard plug shape and includes a ground pin 205, Neutral and Live pins 225, 220, an unlock button 2015, and a fuse cover 210 that is removably coupled to the UK blade 200. The ground, Neutral, and Live pins 205, 225, 220 are arranged in the standard United Kingdom 3-pin socket configuration. Additionally, a fuse (not shown, described below) is housed inside the UK blade 200, behind the fuse cover 210.

As seen in FIG. 4A, the back of the UK blade includes a circular member 231 that that protrudes outwardly and mates with the indented portion 134 on the adapter head 105. The circumference of the circular member 231 includes a plurality of engagement protrusions 230 that mate with the plurality of engagement cavities 115 on the adapter head 105 and, when twisted relative to each other lock in place. Additionally, the circular member 231 has a plurality of alignment rails 235 that mate with the alignment guides 133 on the adapter head 105. Moreover, there is an electric contact area 234 is located between the alignment rails 235. The electric contact area 234 is configured such that it includes Neutral and Live regions (not shown) that each electrically connect to the Neutral and Live pins 225, 220 accordingly when the adapter head 105 and UK blade 200 mate. As such, the Neutral and Live regions (not shown), when in contact with the Live and Neutral contacts 135, 130, on the adapter head 105, electrically connect the pins 225, 220 and contacts 135, 130 in circuit with their respective wires (not shown).

Finally, the user can removably couple the UK blade 200 and the adapter head 105 by aligning the engagement protrusions 230 on the engagement cavities 115, pushing the UK blade 200 and adapter head towards each other, and twisting them, such that they lock in place and are electrically coupled. Notably, as seen in FIG. 4B, the UK blade 200 includes a lock button 215, which mechanically couples with the engagement protrusions 230. The user can engage the lock button 215 to selectively reconfigure the engagement protrusions, such that they can unlock the UK blade 200 and adapter head 105 and break the mating relationship between them. It should be noted that the lock button 215 is IPx4 sealed. Additionally, a gasket (not shown) along the circumference of the circular member 231 provides IPx4 sealing protection when the UK blade 200 and adapter head 105 are engaged and locked. Additionally, as previously noted, in some embodiments, the UK blade 200 and the adapter head 105 each include magnetic components, such that the magnetic components further couple the UK blade 200 and the adapter head 105.

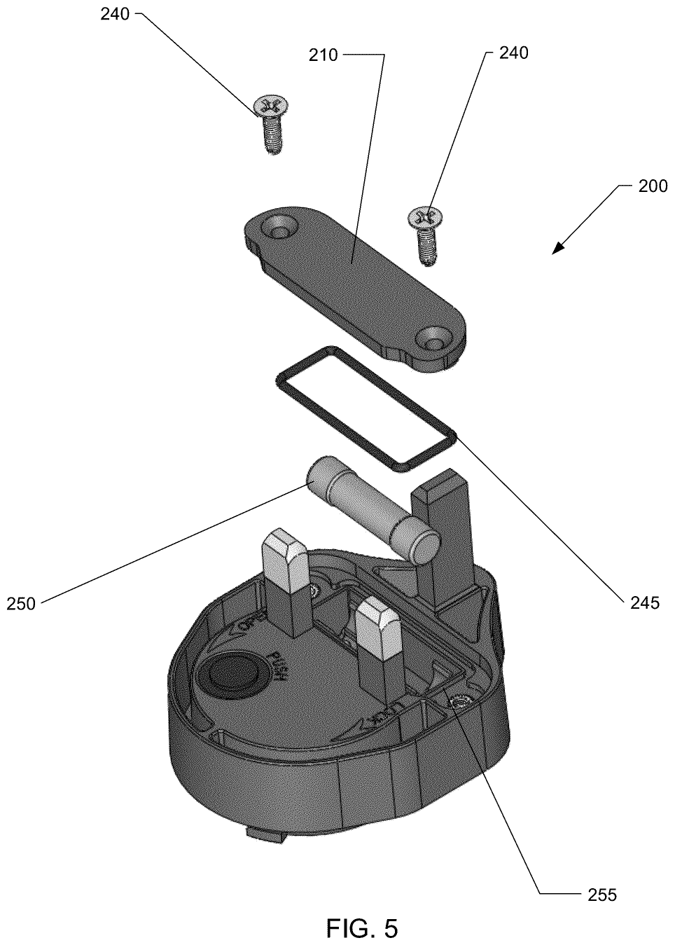

FIG. 5 is an assembly view of an interchangeable IPx4 UK blade with built-in fuse 200. As seen in FIG. 5, the UK blade 200 includes a fuse holder 255, a fuse 250, an O-ring 245, a fuse cover 210, and screws 240. In this embodiment, the fuse 250 sits in the fuse holder 255. The fuse 250 is electrically coupled with the internal, electrical components of the UK blade 200 by way of contact points (not shown) in the fuse holder 255, such that it is part of the Live wire circuit. The O-ring 245 lays on top of the perimeter of the fuse holder 255, such that then the fuse cover 210 is placed on top of the fuse holder 255, the O-ring occupies any voids between the cover 210 and the perimeter of the holder 255. Once the cover is coupled to the UK blade 200 by way of the screws 240, the O-ring compresses as the screws tighten, thereby water-proofing the fuse holder 250. It should be noted that in this embodiment, the screws 240 are M2.5 screws, but other embodiments can use different screws. Additionally, while the fuse holder 255 and fuse 250 are positioned between the ground pin 205 and the Neutral and Live pins 225, 220, the position and orientation of the fuse holder 255 and fuse 250 can vary in alternate embodiments.

In use, the fuse 250 will attenuate any over-voltage coming from the wall socket, by way of the Live wire, by taking the extra voltage load. The fuse responds by breaking the circuit to cut the extra voltage from passing to other components which may not withstand high voltage and can catch fire. It should be noted that the user can then selectively unseal the fuse holder 250 by removing the screws 250. The user can then replace the used fuse 250, with a new fuse 250′ and re-seal the fuse cover 255 using screws 255.

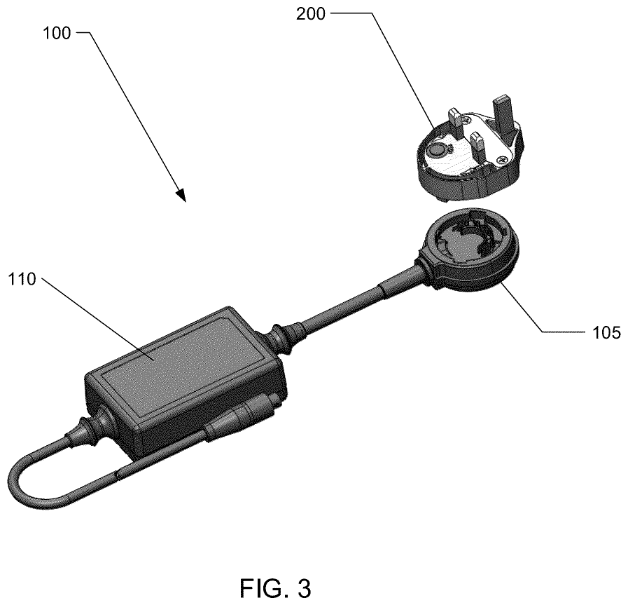

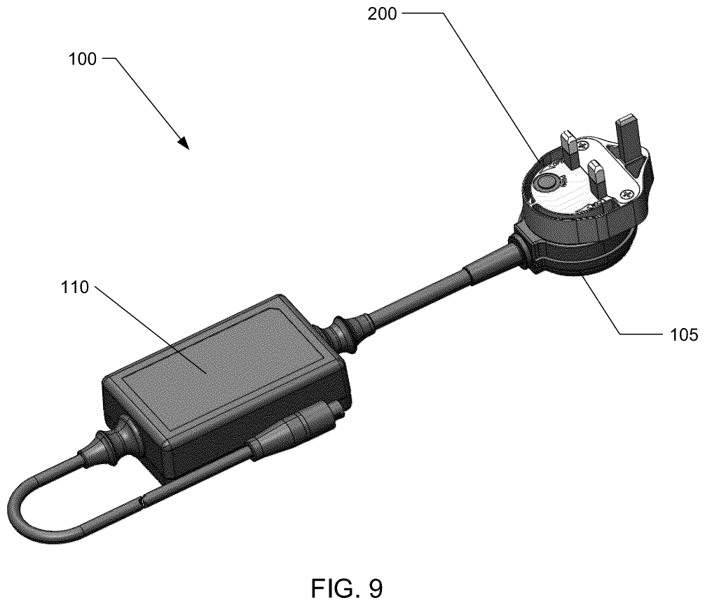

FIG. 3 is an assembly view of a common fixed side power adapter with an interchangeable IPx4 UK blade with built-in fuse. FIG. 3 shows the power adapter 100 before the user couples the UK blade 200 with the adapter head 105. Conversely, FIG. 9 is a perspective view of a common fixed side power adapter with an interchangeable IPx4 UK blade with built-in fuse attached. FIG. 9 shows the power adapter 100 after the user selectively couples and locks the UK blade 200 and the adapter head 105, as described above. In this locked configuration, the UK blade 200 and the adapter head 105 are in a water-sealed connection and the fuse 250 can be easily replaced if it blows out. In this configuration, the electrical cord 101 exits the UK blade 200 at the bottom 125 side of the UK blade 200. In turn, the user is able to safely and inexpensively use the power adapter 100 and UK blade 200 such that when connected to a socket, the blade is not pointed upside down.

### Interchangeable Australia Blade

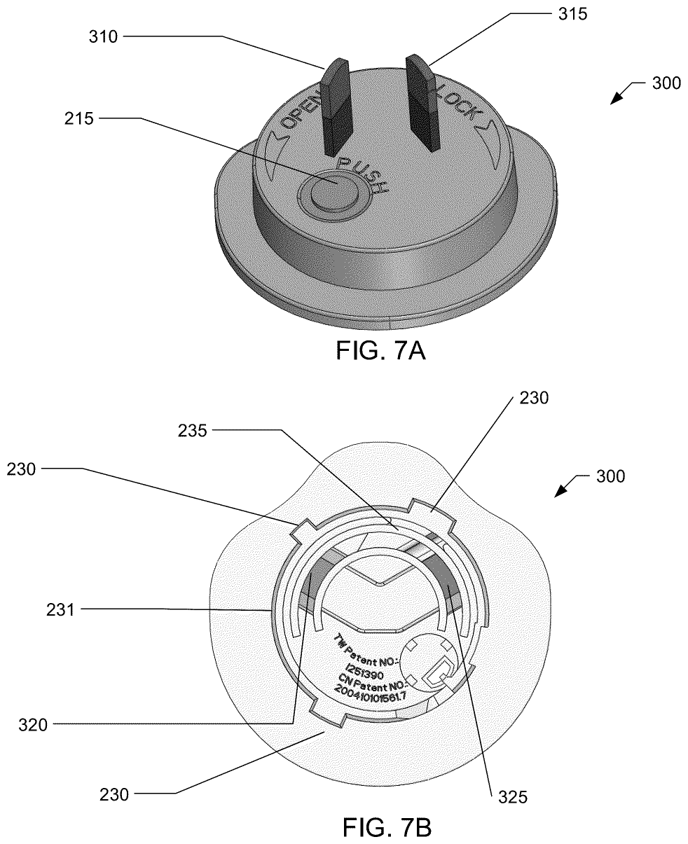

FIG. 7A-B are front and back view of an interchangeable AU Blade, according to an example embodiment of the present disclosure.

The FIGS. 7B-B are front and back view of an interchangeable AU Blade 300. As seen in FIG. 7A, the front of the interchangeable AU blade (AU blade) 300 has a standard plug shape and includes a Neutral pin 315, a Live pin 310, and an unlock button 305. The Neutral and Live pins 315, 310 are arranged in the standard Australia 2-pin socket configuration.

As seen in FIG. 7B, the back of the AU blade includes a circular member 231 that protrudes outwardly and mates with the indented portion 134 on the adapter head 105. The circumference of the circular member 231 includes a plurality of engagement protrusions 230 that mate with the plurality of engagement cavities 115 on the adapter head 105 and, when twisted relative to each other lock in place. Additionally, the circular member 231 has a plurality of alignment rails 235 that mate with the alignment guides 133 on the adapter head 105. Moreover, there is a Live area 320 and a Neutral area 325 located between the alignment rails 235. The Live area 320 and Neutral area 325 each electrically connect to the Neutral and Live pins 315, 310 accordingly when the adapter head 105 and AU blade 300 mate. As such, the Live area 320 and Neutral area 325, when in contact with the Live and Neutral contacts 135, 130, on the adapter head 105, electrically connect the pins 315, 310 and contacts 135, 130 in circuit with their respective wires (not shown).

Finally, the user can removably couple the AU blade 300 and the adapter head 105 by aligning the engagement protrusions 230 on the engagement cavities 115, pushing the AU blade 300 and adapter head towards each other, and twisting them, such that they lock in place and are electrically coupled. Notably, as seen in FIG. 7A, the AU blade 300 includes a lock button 215, which mechanically couples with the engagement protrusions 230. The user can engage the lock button 215 to selectively reconfigure the engagement protrusions, such that they can unlock the AU blade 300 and adapter head 105 and break the mating relationship between them. It should be noted that the lock button 215 is IPx4 sealed. Additionally, a gasket (not shown) along the circumference of the circular member 231 provides IPx4 sealing protection when the AU blade 300 and adapter head 105 are engaged and locked. Additionally, as previously noted, in some embodiments, the AU blade 300 and the adapter head 105 each include magnetic components, such that the magnetic components further couple the AU blade 300 and the adapter head 105.

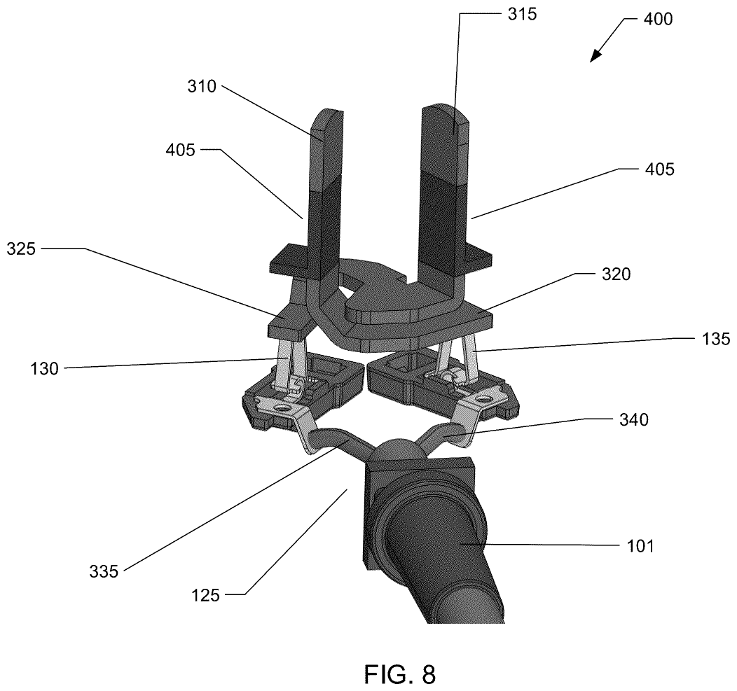

FIG. 8 is an internal view of the interconnection between a common fixed side power adapter head and an interchangeable AU Blade. As seen in FIG. 8 the internal wiring of an adapter head 105 is such that a Live wire 340 couples, physically and electrically, to the Live contact 135 on one side, and a Neutral wire 335 couples, physically and electrically, to the Neutral contact 130 on the other side. The Live and Neutral wires 340, 335, exit the adapter head 105 on the bottom side 125 as an electrical cord 101.

Turning to the internal assembly of the AU blade 400. As seen in FIG. 8 the Live pin 310 and Neutral pin 315 are L-shaped such that they interlock inside the AU blade 400. As such, in each pin 310, 315 there is a vertical, external portion that extends from the front of the AU blade 400, then an internal 405 that is non-conductive, then an internal, horizontal portion that is perpendicular to the pins 310, 315 and serves as the respective Live and Neutral areas 320, 325. As such, for the Live pin 310, the internal configuration is such that the Live pin 310 is diagonal from the Live area 320, and for the Neutral pin 315, the internal configuration is such that the Neutral pin 315 is diagonal from the Neutral area. As seen in FIG. 8, this means that the Live pin 310 is electrically connected to the Live wire 340, via a Live contact 135, which is diagonal from the pin 310. Similarly, the Neutral pin 315 is electrically connected to the Neutral wire 335, via a Neutral contact 130, which is diagonal from the pin 315.

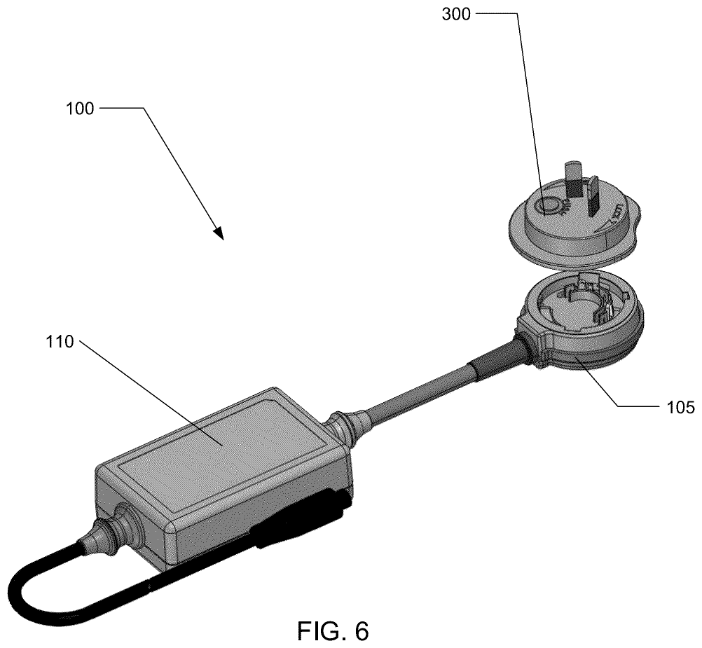

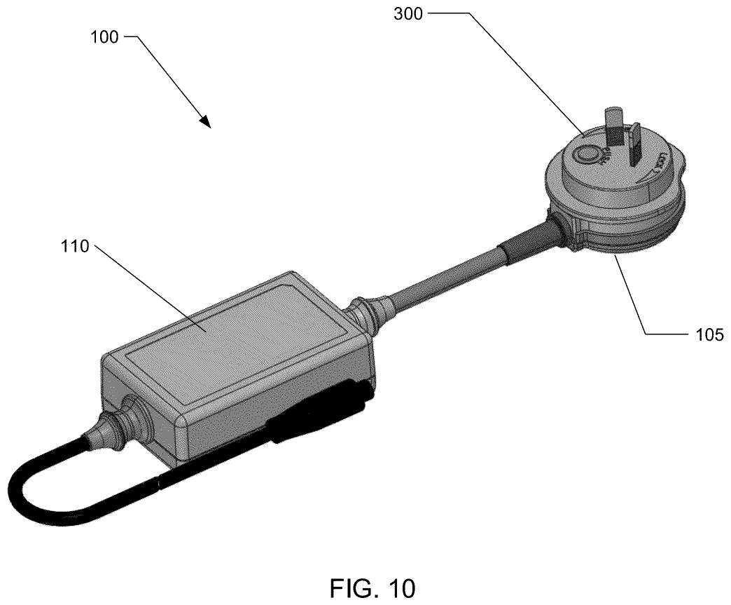

FIG. 6 is an assembly view of a common fixed side power adapter with an interchangeable AU Blade. FIG. 6 shows the power adapter 100 before the user couples the AU blade 300 with the adapter head 105. Conversely, FIG. 10 is a perspective view of a common fixed side power adapter with an interchangeable AU Blade attached. FIG. 10 shows the power adapter 100 after the user selectively couples and locks the AU blade 300 and the adapter head 105, as described above. In this locked configuration, the AU blade 300 and the adapter head 105 are in a water-sealed connection. In this configuration, the electrical cord 101 exits the AU blade 300 at the bottom 125 side of the AU blade 300. Additionally, given the internal configuration of the AU blade 300, the user can use the AU blade 300 with any power adapter. Overall, the user is able to safely and inexpensively use the power adapter 100 and AU blade 300 such that when connected to a socket, the blade is not pointed upside down.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An interchangeable IPx4 United Kingdom blade for a power adapter comprising:
a blade body that mates with a power adapter;
a ground pin;
a neutral pin;
a live pin;
an unlock button;
a fuse holder;
a fuse cover;
and a fuse, wherein
the fuse sits inside the fuse holder,
the fuse cover couples to the blade body with screws,
the blade body removably couples with a power adapter,
and the ground pin, neutral pin, and live pin are configured in a standard United Kingdom socket configuration.

2. The blade of claim 1, wherein the blade body includes engagement protrusions that mate with a power adapter.

3. The blade of claim 2, wherein the unlock button is mechanically connected to the engagement protrusions such that the user can engage the unlock button to selectively reconfigure the engagement protrusions.

4. The blade of claim 2, wherein the blade body mates with the power adapter and the engagement protrusions are oriented such that when the blade body mates with the power adapter, the power adapter points opposite the ground pin.

5. The blade of claim 1, wherein there is an IPx4 O-ring between the fuse holder and the fuse cover.

6. The blade of claim 1, wherein the unlock button is IPx4 sealed with the blade body.

7. The blade of claim 1, wherein when the blade body couples with the power adapter, the power adapter is oriented such that it points opposite the ground pin.

8. The blade of claim 1, wherein the blade body includes an IPx4 gasket around the perimeter of the blade body area that mates with the power adapter.

9. The blade of claim 1, further comprising a blade magnet, wherein the blade magnet is configured to selectively couple with a power adapter magnet on the power adapter.

10. The blade of claim 1, wherein the screws are M2.5 screws.

11. The blade of claim 1, further comprising alignment guides configured to mate with corresponding alignment rails on the power adapter.

12. An interchangeable IPx4 Australia blade for a power adapter comprising:
a blade body that mates with a power adapter;
a neutral pin;
a live pin; and
an unlock button, wherein
the blade body removably couples with a power adapter,
the neutral pin and live pin are configured in a standard Australia socket configuration, and
the neutral pin and live pin are configured inside the blade body such that they have a neutral area and alive area that mate with corresponding neutral contact and live contact points on the power adapter,
wherein the neutral pin and neutral area are configured diagonal to one another, and the live pin and live area are diagonal to one another.

13. The blade of claim 12, wherein the blade body includes engagement protrusions that mate with a power adapter.

14. The blade of claim 13, wherein the unlock button is mechanically connected to the engagement protrusions such that the user can engage the unlock button to selectively reconfigure the engagement protrusions.

15. The blade of claim 13, wherein the blade body mates with the power adapter and the engagement protrusions are oriented such that when the blade body mates with the power adapter, the power adapter points opposite the neutral and live pin.

16. The blade of claim 12, wherein the unlock button is IPx4 sealed with the blade body.

17. The blade of claim 12, wherein the blade body includes an IPx4 gasket around the perimeter of the blade body area that mates with the power adapter.

18. The blade of claim 12, wherein when the blade body couples with the power adapter, the power adapter is oriented such that it points opposite the live and ground pins.

19. The blade of claim 12, further comprising a blade magnet, wherein the blade magnet is configured to selectively couple with a power adapter magnet on the power adapter.

20. The blade of claim 12, further comprising alignment guides configured to mate with corresponding alignment rails on the power adapter.
